(19) United States
(12) Patent Application Publication
(10) Pub. No.: US 2016/0144388 A1
(43) Pub. Date: May 26, 2016

(54) Device for Withdrawing and Dispensing a Viscous Product, Without Taking in Air

(71) Applicant: PROMENS SA, Bellignat (FR)

(72) Inventors: Pascal Hennemann, Vaux Les Saint Claude (FR); Gwénael Doulin, Sainte Euphemie (FR)

(73) Assignee: Promens SA, Bellignat (FR)

(21) Appl. No.: 14/900,247

(22) PCT Filed: Jul. 14, 2014
(86) PCT No.: PCT/EP2014/065007

§ 371 Date: Dec. 21, 2015

(30) Foreign Application Priority Data
Jul. 18, 2013 (FR) 1357085

(51) Int. Cl. B05B 11/00; B05B 15/00

(52) U.S. Cl. CPC B05B 11/3042; B05B 11/0037; B05B 15/005

(57) ABSTRACT

A device for withdrawing and dispensing a viscous product without taking in air is described. The device on the one hand includes a pumping member positioned, by its base, at the open end of a rigid container associated with a retractable flexible inner pouch, intended to receive the product, and on the other hand a plunger tube connected by its upper end to a corresponding part of the pumping member, such that the upper end is partially submerged in the product and the free lower end is completely submerged in the product, such that the plunger tube is made up of a first upper part, with a closed circumference, defining a reference section of the tube and a second lower part submerging the first, with a circumference open by at least one longitudinal slot, made along a generatrix and defining a C- or U-shaped section on that part of the tube.

### TECHNICAL FIELD

The present invention relates to a device for withdrawing and dispensing a viscous product, without taking in air.

It finds application in pharmaceutical or cosmetic products, but also food products, for particularly greasy and pasty products such as mayonnaise for example.

### PRIOR ART

The high viscosity of all these products has the disadvantage of causing a reduction in the release rate of the bottle when emptying the bottle. It is known that these products can be drained of their content using a pump of the airless type associated with the bottle, without taking in air. It is necessary to use either airless bottles with pistons or airless bottles using a pouch. In fact, these systems make it possible to release viscous products more effectively. In certain cases, for products with high viscosity packaged in tall bottles, the pouch systems can lose their release performance and can require a dip tube, which has the effect of considerably slowing the operation of the pump. Indeed, when the pouch is full of product, a traditional dip tube absorbs the product by its lower end, but the pressure drop is then high.

The solution would be to increase the diameter of the dip tube. The problem would remain the same because the volume of product and air to be carried, having increased, would also increase the number of priming strokes.

It is also necessary to take into account the fact that, in the presence of a viscous product, during assembly of the pumping member associated with the dip tube, the air caught inside it creates a blockage which is more difficult to overcome during first actuations if the viscosity of the product is higher.

One could consider solving this problem by having a shorter tube, therefore having a smaller air blockage, thus reducing pressure losses because there is less air to be removed.

But in this case, when finishing using the product, a short tube would not be able to absorb the residual product in the bottom of the pouch. Indeed, by gravity, the product has a tendency to remain in the bottom of the pouch, while the walls thereof collapse at mid-height, preventing the product from rising up to the pump.

### DESCRIPTION OF THE INVENTION

According to a first phase of the inventive approach, it was sought to combine the advantage of the short tube to prime the product rapidly and the long tube to collect the product over the entire height of the pouch.

To this end, the invention relates to a device for withdrawing and dispensing a viscous product, without taking in air, including on the one hand a pumping member positioned, by its base, at the open end of a rigid container associated with a flexible internal retractable pouch, designed to receive the product, and on the other hand a dip tube connected by its upper end to a corresponding portion of the pumping member and of which the free lower end is submerged in the product.

The dip tube is characterized in that it consists of:
a first upper portion, with a closed circumference, defining a reference section of the tube, obtained as a single part with a corresponding portion of the pumping member, and with a predetermined length,
a second lower portion extending the first and being engaged by interlocking with it, having its circumference opened by at least one longitudinal slot formed along a generator and defining a C- or U-shaped section over this portion of the tube, so that the product can penetrate into it simultaneously at every point of the length of its slotted portion, having the effect of a collector, with a greater surface area than the flow area with a closed circumference of its upper portion.

The present invention also relates to the characteristics which will be revealed during the description that follows, and which should be considered in isolation or according to all their technically possible combinations.

This description, given by way of a non-limiting example, will make it easier to understand how the invention can be implemented with reference to the appended drawings wherein:

### BRIEF DESCRIPTION OF THE FIGURES

FIG. 1 shows, in section, a withdrawing device according to the invention, when the product is first used.

FIG. 2 shows the same device according to FIG. 1, when finishing using the product.

FIG. 3 shows, at a smaller scale, an exploded view of the portions constituting the device according to FIGS. 1 and 2, in a first embodiment of the dip tube.

FIG. 4 shows an exploded view similar to FIG. 3 of the portions constituting the device in a second embodiment of the dip tube.

FIGS. 5, 6 and 7 show the tube in the first embodiment of the invention, respectively in a plan view, from above and from below.

FIGS. 8 and 9 show respectively, in a transverse section along line VII-VII of FIG. 7 and at a larger scale, the section of the dip tube in its slotted portion, according to two different embodiments.

FIGS. 10 to 12 are similar views to respectively FIGS. 1 to 3, according to a third embodiment of the invention.

FIG. 13 is a longitudinal section view of the tube of FIG. 12.

FIG. 14 is a transverse section view along the line XIV-XIV of FIG. 13.

FIGS. 15 and 16 are views similar to FIG. 14 according to variants.

### DETAILED DESCRIPTION

The withdrawal and dispensing device 1, globally designated in the figures, includes on the one hand a pumping device (3) positioned, by its base (8) at the open end (4) of a rigid container (5) associated with an internal retractable flexible pouch (6) designed to receive the product (2), and on the other hand to a dip tube (7) connected by its upper end (7a) to a corresponding portion (3a) of the pumping member, so that the upper end (7a) is partially submerged in the product (2) and the free lower end (7b) is totally submerged in the product (2).

According to the invention, the dip tube (7) consists of:
a first upper portion (7A) with a closed circumference, defining a reference section (S1) of the tube (7), engaged hermetically over a corresponding portion (3a) of the pumping member (3) and with a predetermined length (I),
a second lower portion (7B), extending the first (7A), having an circumference opened by at least one longitudinal slot (9) formed along a generator and defining a C- or U-shaped section over this portion of the tube (7), so that the product (2) can penetrate into it simultaneously at every point along the length (L) of its slotted portion (9) having the effect of a collector, with a surface area (S2) greater than the flow area (S1) with a closed circumference of its upper portion (7A).

This allows rapid priming, due to the first short portion with a closed circumference, and a good release rate due to the second portion with an open slotted circumference.

The opening angle of the longitudinal slot (9) of the second lower open portion (7B) of the tube (7) represents a circular sector of which the apex angle (α) is comprised between 45 and 120°.

Initially, it is 90°.

The width “a” of the slot is optimized so that it allows the product to enter easily into the tube through the slot, without however allowing the introduction of the pouch by aspiration at the end of the release.

Tests have demonstrated that, with a tube having a closed circumference, 88% release is obtained, while with the tube partially open according to the invention, 97% release is obtained, with the same highly viscous product.

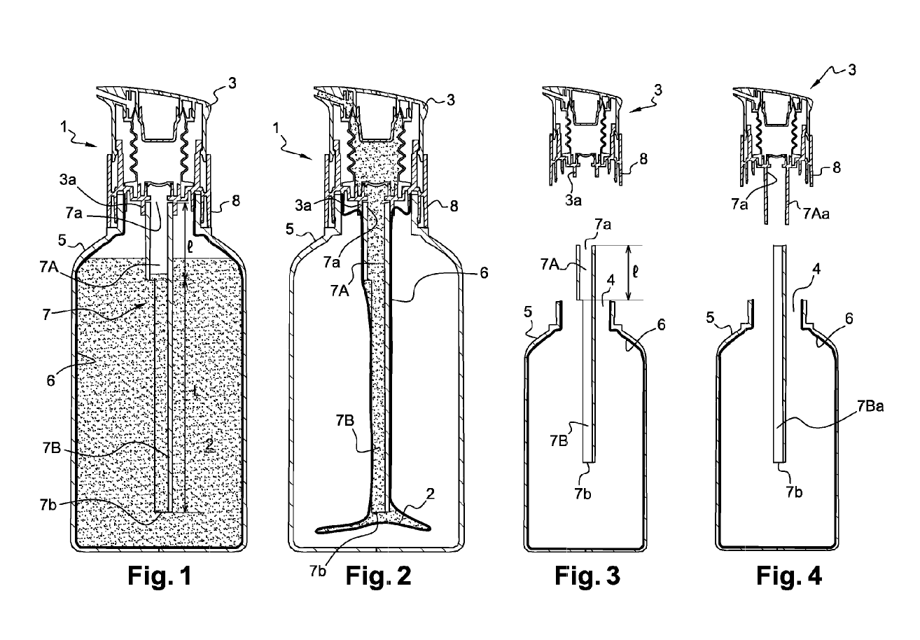

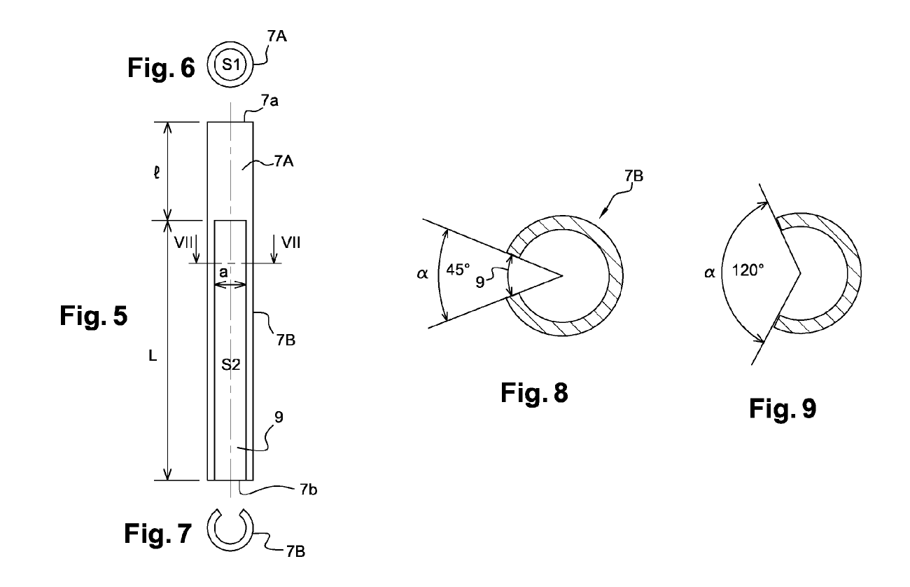

According to a first embodiment (FIGS. 1 to 3), the first and second portions (7A, 7B) of the dip tube (7) are obtained by plastic molding, to form a one-piece element.

According to a second embodiment (FIG. 4), the first and second portions (7A, 7B) of the dip tube (7) are obtained separately from one another, one of them higher, with a closed circumference (7A), being obtained by plastic molding with the base (3a) of the pumping member (3), and with which the lower portion with an open circumference (7B) cooperates by interlocking with it. In this embodiment, the second portion (7B) is inserted inside the first portion (7A).

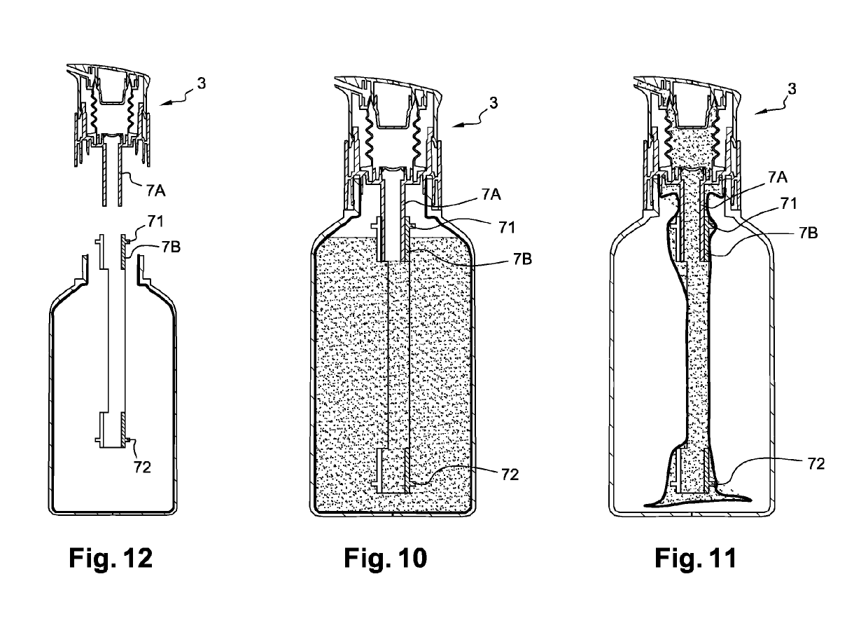

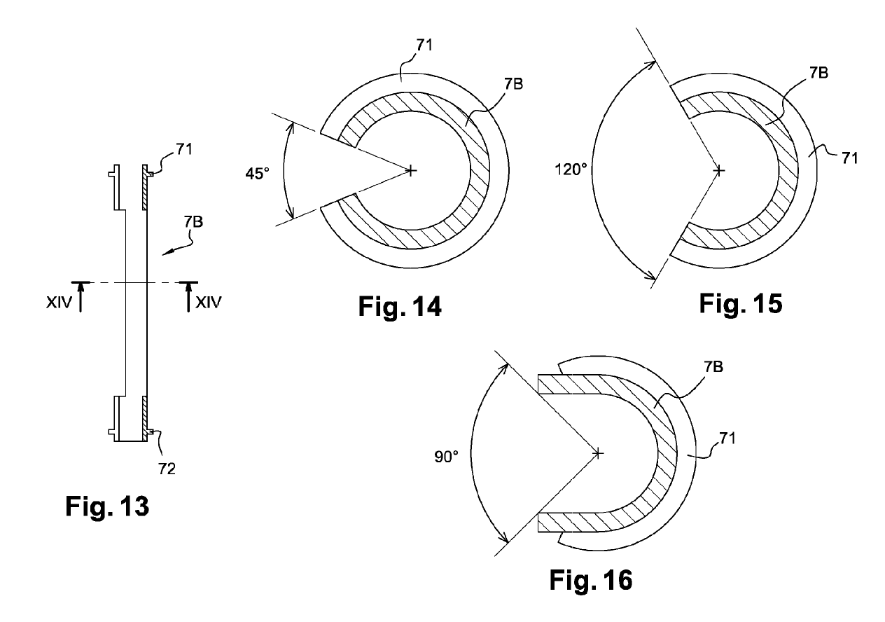

According to a third embodiment, shown in FIGS. 10 to 16, the second portion (7B), split over its entire length, is pressed on outside the first portion (7A). The second portion (7B) further includes a first open reinforcing ring (71) which extends circumferentially and with the same sector angle as the second portion (7B) in a region which covers the first portion (7A). The first reinforcing ring (71) is used to increase the stiffness of the second portion (7B) so as to obtain reinforced clamping over the first portion (7A).

The second portion (7B) includes a second reinforcing ring (72), symmetric with respect to a transverse plane. The presence of the second reinforcing ring (72) is not functional, but rather makes it possible to avoid orienting the second portion during assembly with the pump (3). Each end of the second portion (7B) is identical and can be pressed on over the first portion (7A).

As shown in FIGS. 14 to 16, the sector angle of the second portion (7B) can be selected, as in the first embodiment, for example between 45 and 120°, 90° for example.

In variants that are not shown, the second portion (7B) includes several reinforcing rings at each end.

1-5. (canceled)

6. A device for withdrawing and dispensing a viscous product without taking in air, including on the one hand a pumping member positioned, by its base, at the open end of a rigid container associated with a retractable flexible internal pouch designed to receive the product, and on the other hand a dip tube connected at its upper end to a corresponding portion of the pumping member, so that the upper end is partially submerged in the product and the free lower end is totally submerged in the product, wherein the dip tube comprises:
a first upper portion with a closed circumference, defining a reference section of the tube, obtained as a single part with the pumping member, and with a predetermined length,
a second lower portion extending the first by being engaged to it by interlocking, with a circumference opened by at least one longitudinal slot, formed along a generator and defining a C-shaped or U-shaped section over this portion of the tube, so that the product can enter into it simultaneously at every point of the length of its slotted portion, acting as a collector, with a surface area greater than the flow section with a closed circumference of its upper portion.

7. The device according to claim 6, wherein an opening angle of the longitudinal slot of the second lower open portion of the tube represents a circular sector of which the apex angle (α) is between 45° and 120°.

8. The device according to claim 6, wherein the second lower open portion of the tube includes at least one reinforcing ring extending along a section surrounding the first portion.

9. The device according to claim 8, wherein the second lower open portion of the tube is symmetrical with respect to a transverse plane.

10. The device according to claim 6, wherein the first portion of the dip tube is obtained by plastic molding with a base of the pumping member.
